(19) United States
(12) Patent Application Publication
(10) Pub. No.: US 2014/0362489 A1
(43) Pub. Date: Dec. 11, 2014

(54) ELECTRONIC APPARATUS

(71) Applicant: FUNAI ELECTRIC CO., LTD., Osaka (JP)

(72) Inventor: Yoshiyuki KATO, Osaka (JP)

(73) Assignee: FUNAI ELECTRIC CO., LTD., Osaka (JP)

(21) Appl. No.: 14/266,919

(22) Filed: May 1, 2014

(30) Foreign Application Priority Data
Jun. 5, 2013 (JP) 2013-119180

(51) Int. Cl. H02H 7/20

(52) U.S. Cl. CPC H02H 7/20
USPC 361/103

(57) ABSTRACT

An electronic apparatus has an operation unit, a switchover unit, a state detector, and a control unit. The operation unit is disposed on an apparatus main body. The switchover unit connects or disconnects an output route that is a route for an output signal from the operation unit. The state detector detects a moving body. Based on a detection result by the state detector, the control unit controls the switchover unit to connect or disconnect the output route.

### INCORPORATION BY REFERENCE

This application is based on and claims the benefit of priority from Japanese Patent Application No. 2013-119180 filed on Jun. 5, 2013, the contents of which are hereby incorporated by reference.

### BACKGROUND OF THE INVENTION

1. Field of the Invention

The present invention relates to an electronic apparatus, more particularly, to an electronic apparatus that has an operation unit in an apparatus main body.

2. Description of Related Art

In recent years, an electronic apparatus is put in practical use, which has an operation unit in an apparatus main body and performs operation control based on a voltage signal output from the operation unit. Besides, another electronic apparatus is put in practical use, which has a temperature detector besides the operation unit. The temperature detector is disposed in a place where an unusual temperature is likely to occur in the main body, and is structured to include an element-like temperature fuse, a thermistor and the like.

In connection with the above description, a display apparatus (e.g., JP-A-2003-280572) is proposed, which monitors a panel rear-surface temperature and an environmental temperature by means of a temperature detector. This display apparatus sets an optimum display drive condition for a panel surface temperature after turning-on of a power source to avoid trouble with a display operation and defects such as faulty turning-on of a light and the like.

Usually, voltage signals output from the operation unit and the temperature detector are sent to an A/D converter to be converted into digital data. However, as the number of apparatuses connected to the A/D converter increases, A/D ports (=connection port) run short of and a circuit becomes complicated. Because of this, it is desirable that if possible, an apparatus section whose operating efficiency is low and an apparatus section whose priority is low are not connected to the A/D converter.

### SUMMARY OF THE INVENTION

The present invention has been made in light of the above problems, and in an electronic apparatus that has a plurality of apparatuses whose output destinations for signals are the same, it is an object of the present invention to provide an electronic apparatus which can achieve reduction in connection ports and connection routes and simplify an apparatus structure.

To achieve the above object, an electronic apparatus according to an aspect of the present invention has an operation unit, a switchover unit, a state detector, and a control unit. The operation unit is disposed on an apparatus main body. The switchover unit connects or disconnects an output route that is a route for an output signal from the operation unit. The state detector detects a moving body. Based on a detection result by the state detector, the control unit controls the switchover unit to connect or disconnect the output route. Accordingly, it is possible to switch validity/invalidity of the operation unit in accordance with a situation around the electronic apparatus.

Other features and advantages of the present invention will become more apparent from the following detailed description of preferred embodiments.

### BRIEF DESCRIPTION OF THE DRAWINGS

FIG. 1 is a block diagram showing an apparatus structure of a television apparatus according to a first embodiment.

FIG. 2 is a block diagram showing a function structure of an apparatus relevant to a switchover process according to the first embodiment.

FIG. 3 is a flow chart showing a switchover process according to the first embodiment.

FIG. 4 is a block diagram showing an apparatus structure of a television apparatus according to a second embodiment.

FIG. 5 is a block diagram showing a function structure of an apparatus relevant to a switchover process according to the second embodiment.

FIG. 6 is a flow chart showing a switchover process according to the second embodiment.

FIG. 7 is a flow chart showing a switchover process according to a third second embodiment.

FIG. 8 is a circuit diagram showing a part of a circuit structure of an operation unit according to the first embodiment.

FIG. 9 is a circuit diagram showing a part of a circuit structure of an operation unit according to the third embodiment.

FIG. 10 is an appearance perspective view of a television apparatus according to an embodiment of the present invention.

FIG. 11 is a vertical sectional view of a television apparatus according to an embodiment of the present invention.

### DETAILED DESCRIPTION OF THE PREFERRED EMBODIMENTS

### First Embodiment

Hereinafter, a first embodiment of the present invention is described with reference to drawings. In the meantime, the embodiments described here are examples and the present invention is not limited to the embodiments described here.

### 1-1. Apparatus Structure

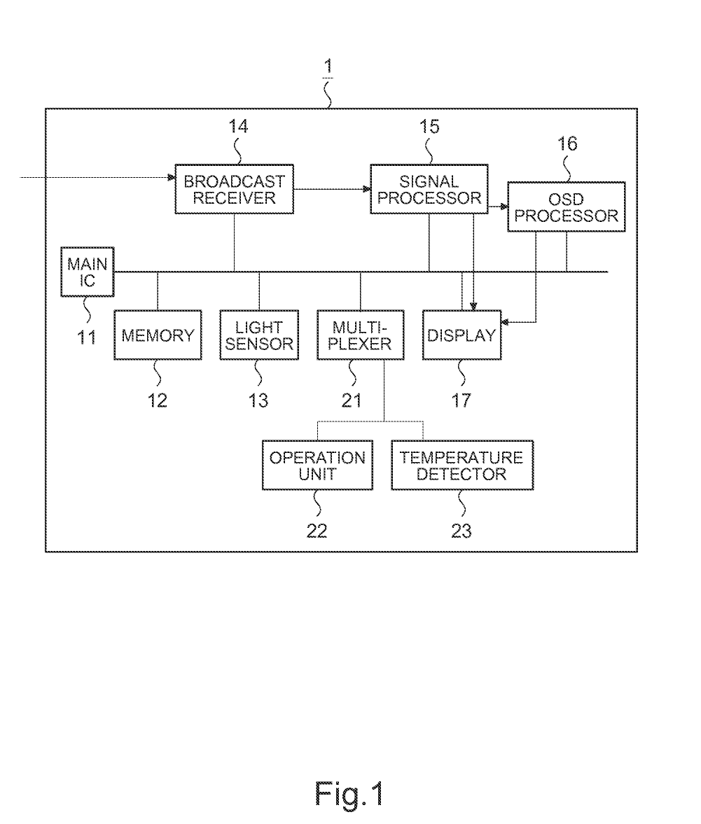

FIG. 1 is a block diagram showing an apparatus structure of a television apparatus 1 (=electronic apparatus) according to the present embodiment. In the meantime, an arrow line shows a flow of image/voice data. Besides, a straight line with no arrow shows a communication bus which a main IC 11 uses to transmit and receive a control signal and the like to and from each apparatus.

The television apparatus 1 is structured to include at least: the main IC 11; a memory 12; a light sensor 13 (=light detector, state detector); a broadcast receiver 14; a signal processor 15; an OSD (On-Screen Display) processor 16; a display 17; a multiplexer 21 (=switchover unit); an operation unit 22; and a temperature detector 23 (=another apparatus).

The main IC 11 performs comprehensive control of an image/voice playback process, a recording process, an output process and the like by controlling driving of each component of the television apparatus 1. For example, the main IC 11 is composed of a plurality of microprocessors.

The memory 12 is a medium that temporarily records various data held by the television apparatus 1. For example, the memory 12 is composed of a writable RAM (Random Access Memory) and the like. For example, the memory 12 plays a roll of a buffer memory that temporarily records process data when various processes are performed by the main IC 11, a command received from a user and the like.

The light sensor 13 includes a light reception device, increases and decreases an output voltage in accordance with intensity of incident light to the light reception device. The light sensor 13 periodically detects a change in the incident light and sends out the detection result to the main IC 11. The main IC 11 performs various adjustments (e.g., brightness adjustment of the display 17 and the like) based on the detection result.

In the meantime, the light sensor 13 of the present embodiment is also used to detect a moving body (e.g., a user) approaching the television apparatus 1 by means of a change in the incident light in a switchover process described later.

The broadcast receiver 14 is connected to an external antenna (not shown) to perform channel selection, reception, frequency conversion, amplification, demodulation and the like of a digital broadcast. The broadcast receiver 14 is structured to include a digital tuner, an error correction unit and the like.

The digital tuner included in the broadcast receiver 14 performs amplification and detection of an intermediate-frequency signal. In this way, acquisition of a TS (=Transport Stream) that is a digital signal of an MPEG 2 form is performed.

In the meantime, the TS is obtained by dividing sound PES (Packetized Elementary Stream), image PES, and additional information of a plurality of contents into fixed-length TS packets and connecting them to each other. The TS is given to the signal processor 15 to be converted into image/voice signals. In the meantime, it is also possible to record the TS into the HDD 15 without converting it. In this case, the broadcast receiver 14 performs a through-output only of the TS.

The TS generated by the broadcast receiver 14 and digital data that are read out from an optical disc by the optical disc drive 16 are input into the signal processor 15. The signal processor 15 is a multi-separation unit that separates these data into a voice digital signal including voice information and an image digital signal including image information. Specifically, for example, the signal processor 15 separates the TS generated by the broadcast receiver 14 into TS packets. And the TS packets are reconnected to generate voice/image PESs.

And the PESs are connected to each other to generate ES (Elementary Stream=coded voice/image data). Further the signal processor 15 decodes and converts the ES into various digital signals. The digital signals obtained by the decoding are output to the OSD processor 16 or the display 17.

The OSD processor 16 is a function component that generates an image signal. The OSD processor 16 converts information to be output by the television apparatus 1 into image data visible to the user and generates an image signal to display the converted image data on the display 17. The generated image signal is output to the display 17.

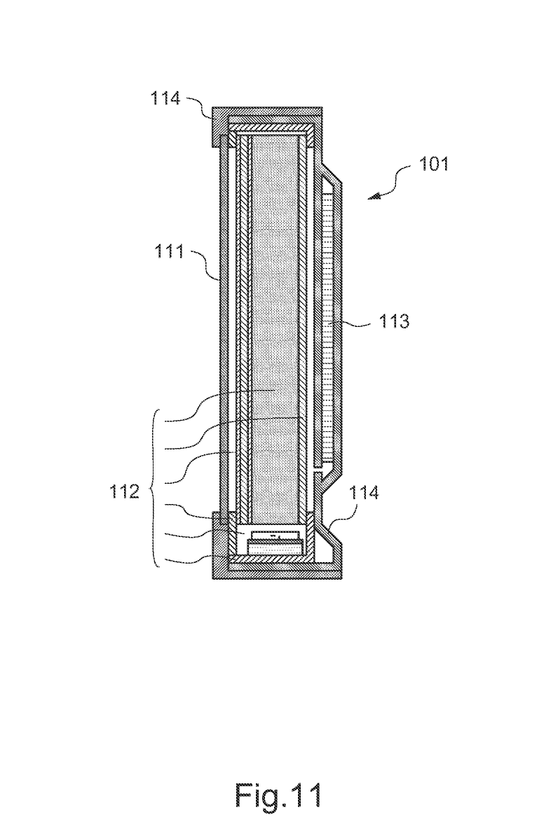

The display 17 is a display apparatus that has, for example, a liquid crystal panel 111 and a backlight module 112 (shown in FIG. 11 described later). The image signal from the signal processor 15 or from the OSD processor 16 is input into the display 17, whereby the display 17 outputs an image.

A plurality of signals are input into the multiplexer 21. The multiplexer 21 performs selection, synthesization or the like of a signal to output one signal. Voltage signals from the operation unit 22 and temperature detector 23 are input into the multiplexer 21 of the present embodiment, and the multiplexer 21 outputs either one of these.

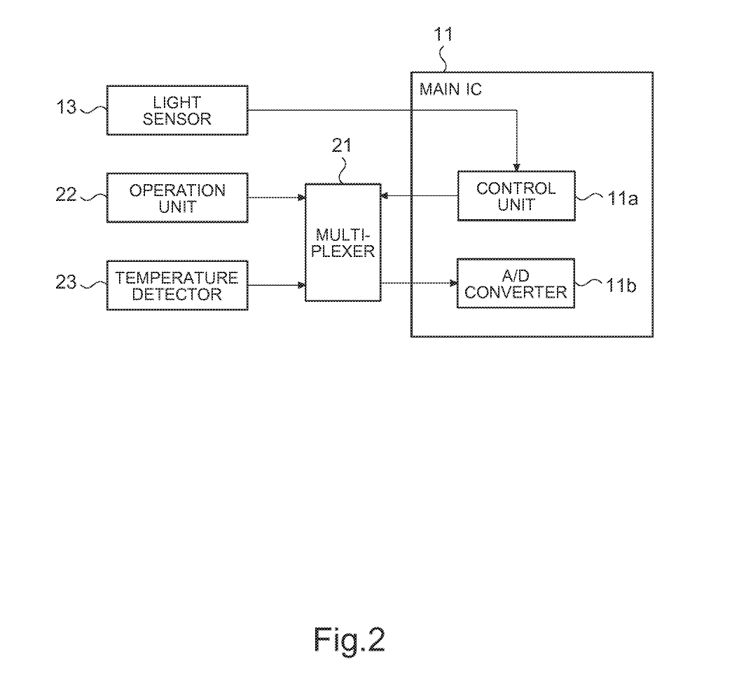

In this way, the multiplexer 21 performs a switchover process that secures only one of a route (=first output route) for connecting the operation unit 22 and an A/D converter 11b (shown in FIG. 2) described later to each other and a route (=second output route) for connecting the temperature detector 23 and the A/D converter 11b to each other. In the meantime, the multiplexer 21 performs the switchover process based on a control signal input from a control unit 11a (shown in FIG. 2) described later.

The operation unit 22 is used by the user to perform a power source startup/stop, channel selection and the like on the television apparatus 1. For example, the operation unit 22 includes a plurality of operation keys (not shown) disposed on a housing of the television apparatus 1. The operation unit 22 accepts a user's operation via these operation keys. When the user's operation is accepted, the main IC 11 performs the power source startup, the channel selection and the like in accordance with content of the operation.

The temperature detector 23 detects a temperature change inside or outside the television apparatus 1 and sends out the detection result to the main IC 11. In this way, it is possible to perform color correction, power source control, trouble detection and the like of the display 17 and improve stability of the television apparatus 1 (especially the display 17).

### 1-2. Connection Route Structure

Here, a function structure of the main IC 11 according to the first embodiment of the present invention and a structure of a connection route for the main IC 11 are described using a block diagram of FIG. 2. FIG. 2 is a block diagram showing schematically a selected apparatus that is connected to the main IC 11 according to the present embodiment.

In FIG. 2, the control unit 11a reads sensor data from the light sensor 13. And the control unit 11a performs analysis of the sensor data and performs switchover control of the multiplexer 21 based on the analysis result. In this way, either one of the voltage signals (hereinafter, called an “output signal”) output from the operation unit 22 and temperature detector 23 is input into the A/D converter 11b (=converter).

The A/D converter 11b applies analog/digital conversion to the output signal input from the operation unit 22 or temperature detector 23 to generate digital data.

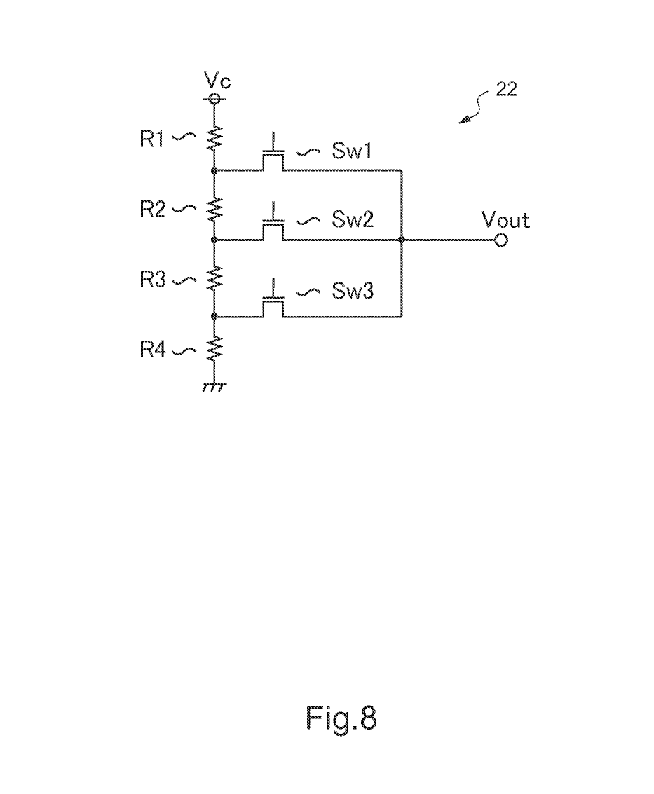

For example, as shown in FIG. 8, in the operation unit 22, resistors R1 to R4 are connected into a ladder form. A voltage divided by the resistors R1 to R4 is output from an output terminal Vout of the operation unit 22 via switches Sw1 to Sw3.

On/off of the switches Sw1 to Sw3 correspond to pushdown/non-pushdown of a predetermined operation key. Because of this, the voltage at the output terminal changes in accordance with a type of a pushed-down operation key. Based on the change in the voltage, the A/D converter 11b determines which operation key is pushed down to generate digital data that indicate the determination result.

In the temperature detector 23, a voltage of the output signal changes in accordance with a detected temperature. Based on the voltage change, the A/D converter 11b generates digital data that indicate the detected temperature.

### 1-3. Switchover Process

Here, a switchover process performed by the main IC 11 according to the first embodiment of the present invention is described.

The control unit 11a connects the operation unit 22 to the A/D converter 11b at a turning-on time of the power source of the television apparatus 1. In the meantime, hereinafter, the connecting to the A/D converter 11b is called “validity.” After the turning-on of the power source, if the user begins to watch the television apparatus 1, the control unit 11a puts the temperature detector 23 into the validity to disconnect the operation unit 22 from the A/D converter 11b. In the meantime, hereinafter, the disconnecting from the A/D converter 11b is called “invalidity.”

In a case where the user approaches the television apparatus 1 to operate the operation unit 22, the incident light to the light sensor 13 increases or decreases. For example, in a case where the user shades light around the television apparatus 1, the incident light decreases. On the other hand, in a case where output light from the backlight module included in the display 17 is reflected by the user, the incident light increases.

In a case where a level of the output signal from the light sensor 13 changes because of the above factors, the control unit 11a applies the switchover control to the multiplexer 21. In this way, the control unit 11a puts the operation unit 22 into the validity, and puts the temperature detector 23 into the invalidity. And, the control unit 11a goes to a state to await an operation of the operation unit 22.

In the meantime, a form may be employed, in which even if the level of the output signal from the light sensor 13 changes, in a case where the level change does not meet a predetermined condition, the switchover control is not be performed. For example, a form may be employed, in which a condition based on a time length, change number, change frequency, time zone when the level of the output signal changes is set beforehand; and in a case where the condition is not met, the switchover is not performed.

According to this, in a situation where it is presumed that necessity for performing the switchover control is low, for example, in a case where a moving body is temporarily detected, for example, in a case where the user approaches the television apparatus 1 and quickly goes away and the like, it is possible to prevent unnecessary switchover control from occurring.

After the control unit 11a performs the above switchover control, in a case where an operation in not performed on the operation unit 22 for a predetermined time, the operation unit 22 is put again into the invalidity and the temperature detector 23 is put into the validity.

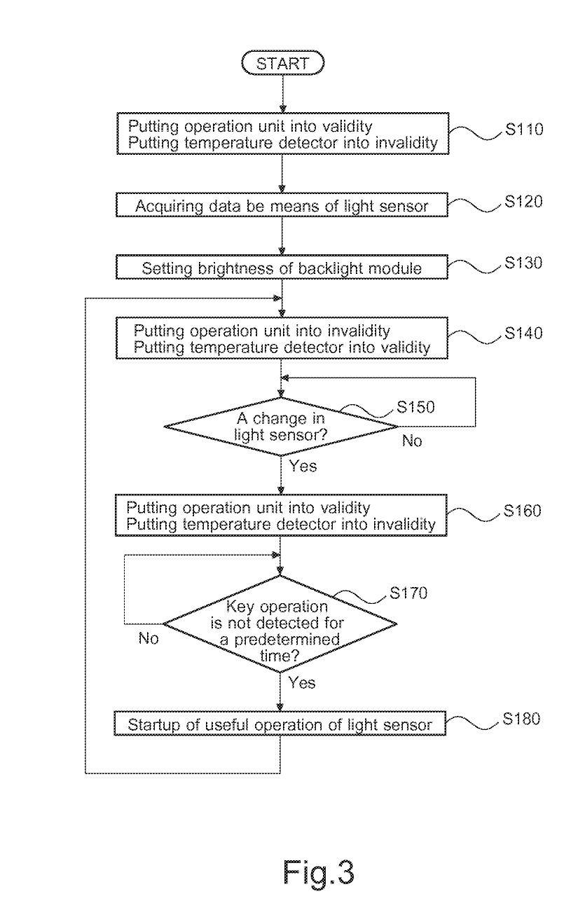

Next, a process flow of the above-described switchover process is described using a flow chart of FIG. 3. In the meantime, the process shown in FIG. 3 is started at the time when the power source of the television apparatus 1 is started up.

After the start of the process, in a step S110, the control unit 11a performs the switchover control of the multiplexer 21 to put the operation unit 22 into the validity and put the temperature detector 23 into the invalidity.

Next, in a step S120, the control unit 11a performs data acquisition by means of the light sensor 13. In other words, the control unit 11a acquires the output signal, which changes in accordance with the incident light to the light reception device included in the light sensor 13, from the light sensor 13 and analyzes the output signal, thereby determining the intensity of the incident light.

Next, in a step S130, the control unit 11a performs brightness setting of the backlight module 112 (shown in FIG. 11 described later) included in the display 17.

Next, in a step S140, the control unit 11a performs the switchover control of the multiplexer 21 to put the operation unit 22 into the invalidity and put the temperature detector 23 into the validity.

Next, in a step S150, the control unit 11a determines whether an amplitude of the output signal from the light sensor 13 changes or not. In other words, the control unit 11a determines whether the intensity of the incident light changes or not. In a case where a change is not detected, the control unit 11a again goes to the step S150 to continuously monitor the output signal from the light sensor 13.

On the other hand, in a case where a change is detected, in a step S160, the control unit 11a performs the switchover control of the multiplexer 21 to put the operation unit 22 into the validity and put the temperature detector 23 into the invalidity.

Next, in a step S170, the control unit 11a determines whether a user's operation on the operation unit 22 is detected or not during a predetermined time after performing the switchover control of the step S160. In a case where an operation is detected during the predetermined time (i.e., in a case of NO in the step S160), the control unit 11a again goes to the step S170 to continuously monitor a key operation.

On the other hand, in a case where a user's operation on the operation unit 22 is not detected even if the predetermined time elapses (i.e., in a case of YES in the step S160), in a step S180, the control unit 11a controls the light sensor 13 to start a usual operation. In other words, the control unit 11a periodically detects a change in the incident light by means of the light sensor 13 and starts a process that performs various adjustments (e.g., brightness adjustment of the display 17) based on the detection result.

When the usual operation of the light sensor 13 is started, the control unit 11a again goes to the step S140 to continuously perform the switchover process. In the meantime, the process flow ends, for example, in a case where the power source of the television apparatus 1 is stopped and the like.

### 1-4. Outer and Inner Appearances of the Television Apparatus

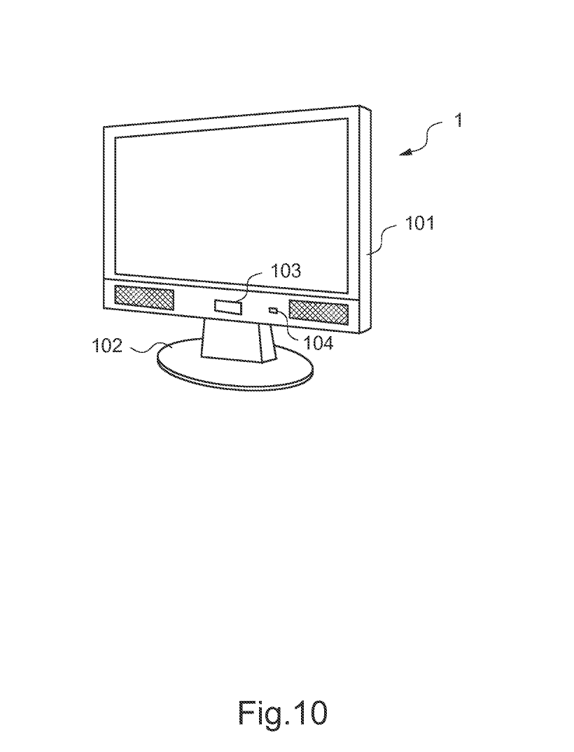

Outer and inner appearances of the above-described television apparatus 1 are described using FIG. 10 and FIG. 11. In the meantime, hereinafter, a side where an image of the television apparatus 1 is displayed is called a front side and an opposite side is called a rear side.

FIG. 10 is an appearance perspective view of the television apparatus 1. FIG. 11 is a vertical sectional view of the television apparatus 1. As shown in FIG. 10, the television apparatus 1 includes a television apparatus main body 101 (=apparatus main body), a stand 102, an operation key 103, and a sensing unit 104 (=state detector).

Besides, as shown in FIG. 11, the television apparatus main body 101 has the liquid crystal panel 111, the backlight module 112 of edge-light type, a control board 113, and a cabinet 114 that houses these.

The liquid crystal panel 111 controls a transmission factor of light emitted from the backlight module 112 behind the panel, besides reflects the light, and displays a predetermined image on a front surface (left main surface of FIG. 11) of the liquid crystal panel 111.

The backlight module 112 is an illumination apparatus that is disposed behind the liquid crystal panel 111 and shines the light, which is for displaying the predetermined image, onto the liquid crystal panel 111.

In the present embodiment, the operation key 103 is a part of the operation keys included in the operation unit 22. Besides, the sensing unit 104 includes the light sensor 13 shown in FIG. 2 and is used to detect the user who approaches the front surface of the television apparatus 1.

### 1-5. Features of the Present Embodiment

In the first embodiment described above, the television apparatus 1 has the operation unit 22, the multiplexer 21, the light sensor 13, and the control unit 11a. The operation unit 22 is disposed on the main body of the television apparatus 1. The multiplexer 21 connects or disconnects an output route of the operation unit 22. The light sensor 13 detects the user (example of a moving body). Based on the detection result by the light sensor 13, the control unit 11a controls the multiplexer 21 to connect or disconnect the output route.

According to this, the television apparatus 1 performs connection/disconnection between the operation unit 22 and its output destination in accordance with whether a moving body (user) exists around the television apparatus 1 or not to switch the validity/invalidity of the operation unit 22. Accordingly, it is possible to switch the validity/invalidity of the operation unit 22 in accordance with the situation around the television apparatus 1.

For example, the television apparatus 1 puts the operation unit 22 into the invalidity in a case only where it is presumed that probability of the user operating the operation unit 22 is low. Because of this, it is possible to achieve reduction in power consumed by the operation unit 22 and avoid a situation where the user cannot use the operation unit 22. Besides, in a situation where the user does not exist around the television apparatus 1, it is possible to prevent the operation unit 22 from malfunctioning because of contact with a peripheral apparatus and the like.

Besides, in the first embodiment, the control unit 11a detects the user existing around the television apparatus 1 by using the light sensor 13 and connects the output route in a case where the user is detected. Further, the control unit 11a controls the multiplexer 21 to disconnect the output route in a case where the user is not detected.

According to this, in the situation where a moving body (user) does not exist and it is presumed that necessity for operating the operation unit 22 is low, the television apparatus 1 puts the operation unit 22 into the invalidity. In this way, it is possible to achieve the reduction in the power consumption and the prevention of the malfunction.

Besides, in the first embodiment, in the case where the user is detected by the light sensor 13, the control unit 11a presumes the probability of the operation unit 22 being operated by the user based on the detection time, detection number, detection frequency, or detection time zone of the user. Further, the control unit 11a disconnects the output route in a case where the probability is smaller than a threshold value.

According to this, in the case where a moving body (user) is detected around the main body of the television apparatus 1, without putting the operation unit 22 into the validity with no conditions, it is possible to switch the validity/invalidity of the operation unit 22 considering a possibility that the user operates the operation unit 22.

Accordingly, a condition for putting the operation unit 22 into the validity is set. In other words, in a case where the user exists near the television apparatus 1 but it is presumed that the probability of the user using the operation unit 22 is low, the operation unit 22 is put into the invalidity. Because of this, under the above situation, it is possible to achieve power saving. Besides, even if the operation key is pushed down because of a factor unimaginable by the user, for example, an accident that an object around the television apparatus 1 contacts the operation key or the like, it is possible to put this into the invalidity. Because of this, it is possible to prevent the malfunction of the television apparatus 1.

Besides, in the first embodiment, the multiplexer 21 is connected to the first route that is the route for the output signal from the operation unit 22 and to the second route that is the route for the temperature detector 23 which is an apparatus other than the operation unit 22 of the television apparatus 1. Besides, based on an instruction from the control unit 11a, the multiplexer 21 connects either one of the first route and the second route and disconnects the other.

According to this, in the situation where it is presumed from a surrounding environment that the necessity for making the operation unit 22 function is low, it is possible to use a connection port for an output destination apparatus of the operation unit 22 as a connection port for another apparatus (e.g., temperature detector 23). In this way, it is possible to reduce connection ports for output destinations.

Besides, in the first embodiment, the television apparatus 1 further has the A/D converter 11b that receives the inputs of the voltage signals from the operation unit 22 and temperature detector 23 to perform conversion. Besides, based on an instruction from the control unit 11a, the multiplexer 21 connects either one of the operation unit 22 and the temperature detector 23 to the A/D converter 11b.

According to this, in the situation where it is presumed from the surrounding environment that the necessity for making the operation unit 22 function is low, it is possible to use the connection route and connection port for connecting the operation unit 22 to the A/D converter 11b as a connection route and connection port for connecting another apparatus (e.g., the temperature detector 23) to the A/D converter 11b. For example, it is possible to use the connection port for connecting the operation unit 22 and the A/D converter 11b to each other as the connection port for connecting the temperature detector 23 and the A/D converter 11b to each other. In this way, it is possible to reduce the connection routes and connection ports for the A/D converter 11b. Because of this, it is possible to achieve simplification of the apparatus structure.

### Second Embodiment

Next, a second embodiment of the present invention is described with reference to drawings. In the meantime, the second embodiment is characterized in that a method for detecting the user and a method for switching the connection route are different from the first embodiment.

### 2-1. Apparatus Structure

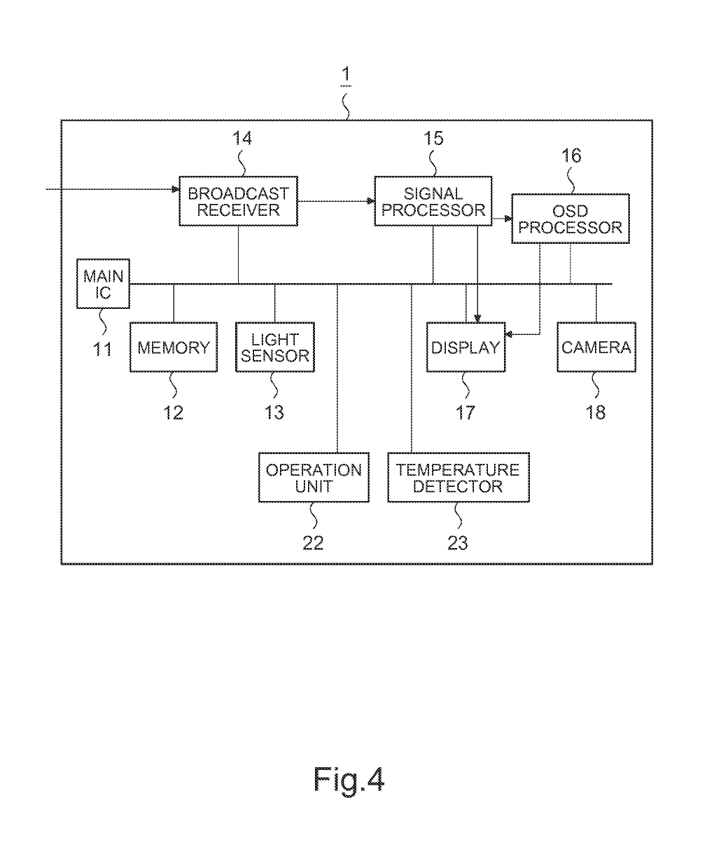

As shown in FIG. 4, the television apparatus 1 of the present embodiment includes a camera 18 (=image taking apparatus, state detector) besides the structure (FIG. 1) of the first embodiment. The camera 18 is included, for example, in the sensing unit 104 shown in FIG. 10 and used to take an image of an environment of the front surface of television apparatus 1.

Besides, as shown in FIG. 4, the television apparatus 1 of the present embodiment does not have the multiplexer 21, and both the operation unit 22 and the temperature detector 23 are connected to the main IC 11.

### 2-2. Connection Route Structure

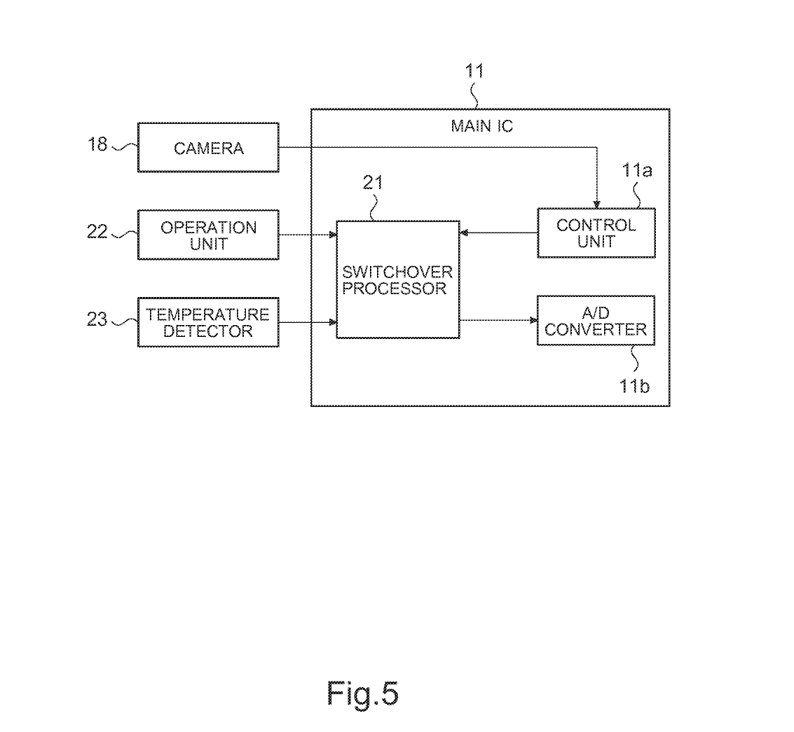

Here, a structure of the connection route for the main IC 11 according to the second embodiment of the present invention is described using a block diagram of FIG. 5. FIG. 5 is a block diagram showing schematically a selected apparatus that is connected to the main IC 11 according to the present embodiment.

In FIG. 5, the main IC 11 reads taken image data from the camera 18. And the main IC 11 analyzes the taken image data, and based on the analysis result, performs a switchover process by means of a switchover processor 11c (=switchover unit). In this way, either one of the voltage signals input from the operation unit 22 and temperature detector 23 is put into the validity and the other is put into the invalidity.

The switchover processor 11c accepts anytime the inputs of the voltage signals from the operation unit 22 and temperature detector 23. Besides, the switchover processor 11c performs an internal function switchover to transmit either one only of these to the control unit 11a. In other words, the switchover processor 11c includes a plurality of functions that have different methods for processing the input voltage signal. By switching the functions pursuant to an instruction from the control unit 11a, it is possible to change an output from the switchover processor 11c.

### 2-3. Switchover Process

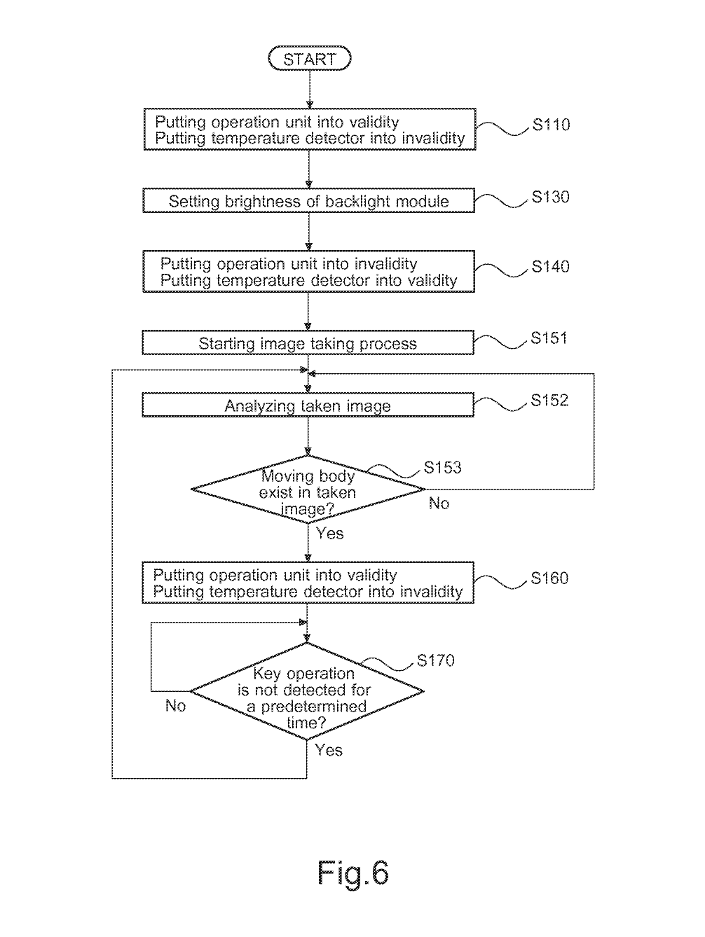

Here, a process flow of a switchover process performed by the television apparatus 1 according to the second embodiment of the present invention is described using a flow chart of FIG. 6. In the meantime, the same processes as FIG. 3 are indicated by the same step numbers and description of them is skipped.

In the present process flow, processes (step S120, step S180) in FIG. 3 relevant to the light sensor 13 are not performed. Instead, in a step S151, an image taking process by the camera 18 is performed. In the meantime, as an image taking method of the camera 18 may be, for example, a form of periodically taking a still image or a form of always taking a moving image.

Next, in a step S152, the control unit 11a applies an analysis process to the image taken by the camera 18. In this way, a moving body included in the taken image, for example, a user existing near the television apparatus 1 is selected.

Next, in a step S153, the control unit 11a determines whether or not the moving body is successfully selected from the taken image and a percentage of the moving body to the taken image exceeds a predetermined threshold value. In other words, it is determined whether the moving body is within a predetermined-distance area from the television apparatus 1 or not.

In a case where the moving body is not included in the taken image, or in a case where the percentage of the moving body does not exceed the predetermined threshold value (i.e., a case of NO in the step S153), the control unit 11a again goes to the step S152. And, the control unit 11a continuously performs analysis of the taken image and selection of a moving body.

On the other hand, in a case where the percentage of the moving body to the taken image exceeds the predetermined threshold value (i.e., a case of YES in the step S153), the control unit 11a goes to a step S160. In the meantime, in the step S153, a form may be employed, in which the above determination is performed a plurality of times and the control unit 11a goes to the step S160 in a case only where the number of events of exceeding the threshold value reaches a predetermined number.

Like the first embodiment, the present process flow ends, for example, in the case or the like where the power source of the television apparatus 1 is stopped.

### 2-4. Outer and Inner Appearances of the Television Apparatus

Because of the same structure as the first embodiment, description is skipped here.

### 2-5. Features of the Present Embodiment

In the second embodiment described above, a state of the surrounding environment is detected by means of the camera 18 that takes an image. Besides, based on the analysis result of the image taken by the camera 18, the control unit 11a detects a user who exists around the television apparatus 1.

In this way, in the model of television apparatus 1 that incorporates the camera 18, the user existing around the television apparatus 1 is detected by means of the camera 18. Accordingly, it is possible to perform the switchover process in accordance with the detection result.

### Third Embodiment

Next, a third embodiment of the present invention is described with reference to drawings. In the meantime, the third embodiment is characterized in that the operation unit 22 includes a temperature detection device.

### 3-1. Apparatus Structure

The third embodiment has the same structure as the first embodiment, but the function of the operation unit 22 is partially different. In the operation unit 22 of the present embodiment, some of the resistors R1 to R4 that compose the operation key are each a temperature detection device such as a thermistor or the like. According to this, a change occurs in an output voltage from the operation unit 22 in accordance with a temperature, and the control unit 11a detects the change.

By using the temperature detection device, it is possible to finely set an output range of the output voltage in a case where the operation key is pushed down. The control unit 11a detects a temperature drift that occurs in the voltage during an operation time of the operation unit 22 by using data acquired from the output voltage. And based on the detected temperature drift, various corrections are performed.

For example, a color tone correction of the display 17 is performed based on the temperature drift. Besides, for example, in the case where the operation unit 22 is pushed down, it is also possible to perform correction of a temperature detected by the temperature detector 23 based on a difference between a usual voltage and a voltage influenced by a temperature change.

Besides, by using the temperature detection device, the control unit 11a can perform temperature measurement by means of the operation unit 22 only. This is possible by using a structure which supposes the state (hereinafter, called a “spurious pushdown state”) of the operation unit 22 being pushed down in a spurious manner in a case where a moving body is not detected.

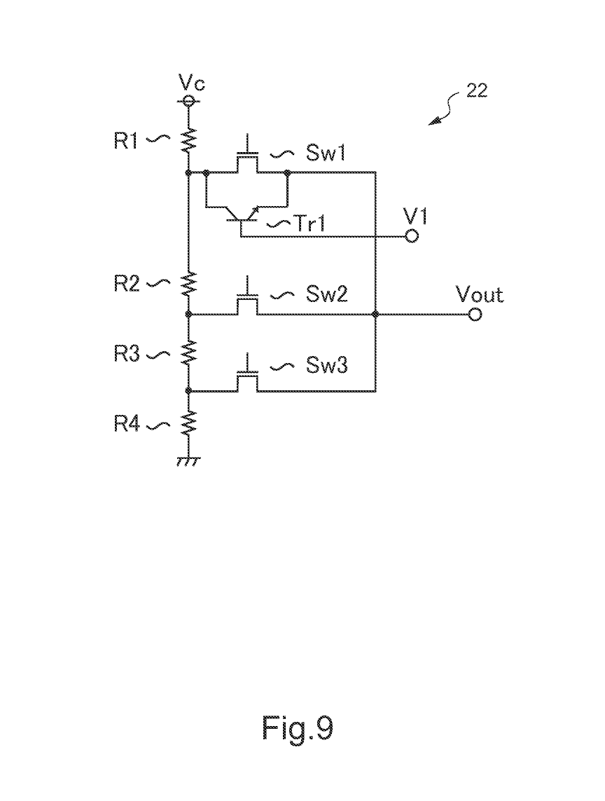

More specifically, for example, as shown in FIG. 9, a transistor Tr is disposed, which is connected to an input terminal and output terminal of the switch Sw1. A base of the transistor Tr is connected to the control unit 11a via an input terminal V1. By controlling an electric current that flows in the base of the transistor Tr, the control unit 11a can produce a spurious pushdown state in a state where the operation unit 22 is not pushed down.

According to the above structure, the spurious pushdown state is produced in the state where a moving body is not detected, and an output voltage from the temperature detection device included in the operation unit 22 is input into the A/D converter 11b. In this way, it is possible to measure a temperature.

In the meantime, in the spurious pushdown state, the control unit 11a processes the output voltage obtained from the operation unit 22 as a voltage different from a usual output voltage (voltage that is output when the operation unit 22 is pushed down). In other words, in the spurious pushdown state, all of a channel selection process, a sound volume adjustment process and the like based on the output voltage obtained from the operation unit 22 are put into the invalidity. In this way, the malfunction of the television apparatus 1 is prevented.

### 3-2. Connection Route Structure

Because of the same structure as the first embodiment, description is skipped here.

### 3-3. Switchover Process

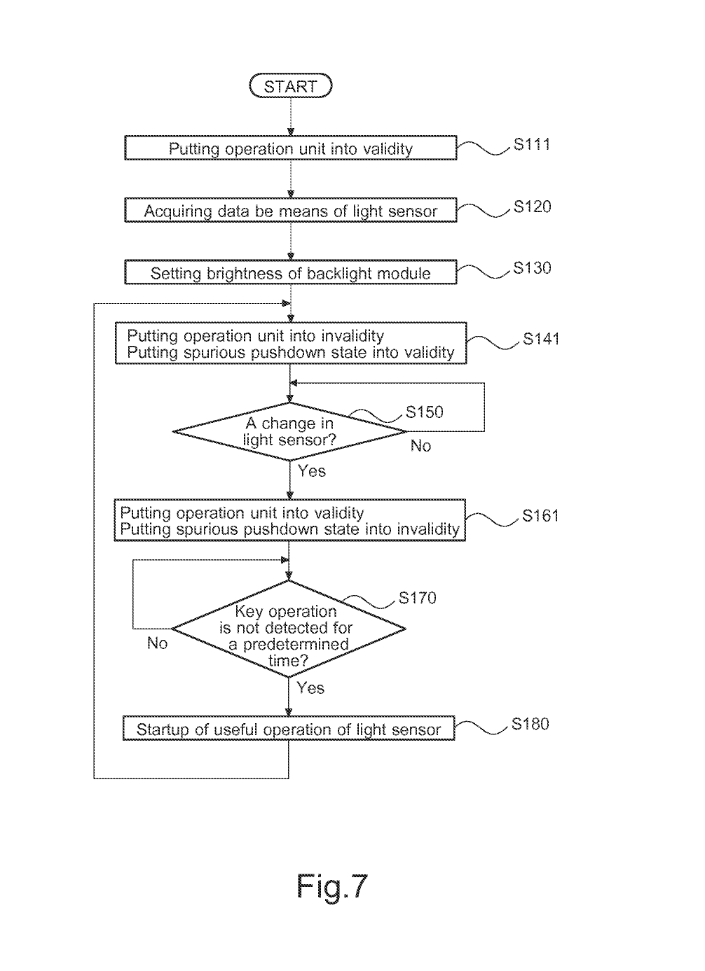

Here, a process flow of a switchover process performed by the television apparatus 1 according to the third embodiment of the present invention is described using a flow chart of FIG. 7. In the meantime, the same processes as FIG. 3 are indicated by the same step numbers and description of them is skipped.

In the present embodiment, processes (e.g., step S110 and the like) relevant to the temperature detector 23 are not performed. Instead, in a step S111, the control unit 11a performs the switchover control of the multiplexer 21 to put the operation unit 22 into the validity.

Next, after performing the step S120 and the step S130, in a step S141, the control unit 11a controls the operation unit 22 to put the operation unit 22 into the invalidity and put the spurious pushdown state into the validity. In this way, a state is obtained, in which the temperature measurement is possible by means of the temperature detection device included in the operation unit 22.

Next, in the step S150, the control unit 11a determines whether a change in the level of the output signal from the light sensor 13 is detected or not. In a case where a change is not detected, the control unit 11a again goes to the step S150 to continuously monitor the output signal from the light sensor 13.

On the other hand, in a case where a change is detected, in a step S161, the control unit 11a performs the control of the operation unit 22 to put the operation unit 22 into the validity and put the spurious pushdown state into the invalidity. In this way, the temperature measurement by the temperature detection device included in the operation unit 22 is stopped.

After performing the step S161, the step S170 and the following processes are performed. In the meantime, like the first embodiment, the present process flow ends, for example, in the case or the like where the power source of the television apparatus 1 is stopped.

### 3-4. Outer and Inner Appearances of the Television Apparatus

Because of the same structure as the first embodiment, description is skipped here.

### 3-5. Features of the Present Embodiment

According to the present embodiment described above, the operation unit 22 includes a voltage division circuit that changes the voltage of the output signal and a thermistor included in the voltage division circuit. Besides, based on a change in a voltage divided by the voltage division circuit, the control unit 11a performs adjustment control or the temperature measurement of the television apparatus 1.

According to the present embodiment, the temperature detection devices such as the thermistors or the like are used as alternatives of some of the resistors R1 to R4 that compose the voltage division circuit of the operation unit 22. According to this, it is possible to change the voltage of the output signal from the operation unit 22 in accordance with a temperature change. Bedsides, it is possible to perform various adjustments based on the change, for example, brightness adjustment of the backlight module 121 and the like based on the temperature change.

For example, it is possible to perform various adjustments based on the temperature drift that occurs in the voltage during the operation time of the operation unit 22. Besides, the temperature measurement using the operation unit 22 is possible.

### Other Embodiments

Hereinbefore, the present invention is described using the preferred embodiments and examples. However, the present invention is not necessarily limited to the above embodiments, and it is possible to make various modifications within the scope of the technical concept and put them into practical use.

Accordingly, the present invention is also applicable to the following forms.

(A) In the above embodiments, as the electronic apparatus that performs the switchover process of the present invention, the television apparatus 1 is described as an example. However, a form may be employed, in which the switchover process of the present invention is performed in an electronic apparatus other than the television apparatus 1. For example, a form may be employed, in which the switchover process is performed in recording-playback apparatuses such as a HDD recorder and the like or in reception apparatuses such as a STB (Set Top Box) and the like.

(B) In the above embodiments, as the apparatus for detecting the moving body, for example, the user, the light sensor 13 and the camera 18 are described as examples. However, a form may be employed, in which another apparatus is used to detect the user. For example, a form may be employed, in which a dimmer sensor, an infrared sensor, a laser sensor, an ultrasonic sensor or the like is used to detect the user.

What is claimed is:

1. An electronic apparatus comprising:
an operation unit disposed on an apparatus main body;
a switchover unit that connects or disconnects an output route which is a route for an output signal from the operation unit;
a state detector that detects a moving body; and
a control unit that controls the switchover unit to connect or disconnect the output route based on a detection result by the state detector.

2. The electronic apparatus according to claim 1, wherein
the control unit controls the switchover unit to detect a moving body existing around the electronic apparatus by using the state detector, connect the output route in a case where the moving body is detected, and disconnect the output route in a case where the moving body is not detected.

3. The electronic apparatus according to claim 2, wherein
in a case where the moving body is detected by the state detector, based on a detection time, detection number, detection frequency, or detection time zone of the moving body, the control unit presumes probability that the operation unit is operated by the moving body, and disconnects the output route in a case where the probability is smaller than a threshold value.

4. The electronic apparatus according to claim 1, wherein
the switchover unit is connected to a first output route that is a route for the output signal from the operation unit and to a second output route that is a route for an output signal from another apparatus other than the operation unit of the electronic apparatus, connects either one of the first output route and the second output route, and disconnects another based on an instruction from the control unit.

5. The electronic apparatus according to claim 4, wherein
the electronic apparatus includes a converter that receives an input of a voltage signal from the first output route and the second output route to perform conversion; and
the switchover unit connects either one of the first output route and the second output route to the converter based on the instruction from the control unit.

6. The electronic apparatus according to claim 1, wherein
the operation unit includes a voltage division circuit that changes a voltage of the output signal and a temperature detection device included in the voltage division circuit; and
the control unit performs adjustment control or temperature measurement of the electronic apparatus based on a change in a voltage divided by the voltage division circuit.
